(19) United States
(12) Patent Application Publication
(10) Pub. No.: US 2026/0208081 A1
(43) Pub. Date: Jul. 23, 2026

(54) OIL PURIFICATION APPARATUS

(71) Applicant: TWO-N Co., Ltd., Pohang-si (KR)

(72) Inventor: Jae Hun KIM, Daegu (KR)

(73) Assignee: TWO-N Co., Ltd., Pohang-si (KR)

(21) Appl. No.: 19/577,813

(22) Filed: Mar. 25, 2026

Related U.S. Application Data
(63) Continuation of application No. PCT/KR2024/014531, filed on Sep. 25, 2024.
(63) Continuation of application No. PCT/KR2024/014530, filed on Sep. 25, 2024.

(30) Foreign Application Priority Data
Sep. 26, 2023 (KR) 10-2023-0129140
Sep. 26, 2023 (KR) 10-2023-0129158
Sep. 20, 2024 (KR) 10-2024-0127487
Sep. 20, 2024 (KR) 10-2024-0127488

(51) Int. Cl. B01D 36/00; B01D 29/03; B01D 29/56; B01D 29/96; C10G 31/09

(52) U.S. Cl. CPC B01D 36/005; B01D 29/03; B01D 29/56; B01D 29/965; C10G 31/09

(57) ABSTRACT

The disclosed oil purification apparatus comprises: a housing having a purification space formed therein; an inlet formed at one side of the housing and connected to the purification space, into which oil containing at least one of moisture and impurities is introduced; a first outlet formed at an upper side of the housing, through which oil purified in the purification space is discharged; a second outlet formed at a lower side of the housing, through which at least one of the moisture and impurities separated from the oil is discharged; and a filter unit disposed between the inlet and the first outlet in the purification space to remove at least one of the moisture and impurities contained in the oil, wherein the introduced oil passes through the filter unit and is discharged to the first outlet.

### CROSS-REFERENCE TO RELATED APPLICATIONS

This application is a bypass continuation application filed under 35 U.S.C. § 111(a) which claims the benefit of International Application Nos. PCT/KR2024/014530 and PCT/KR2024/014531, both filed on Sep. 25, 2024, the entire contents of which are hereby incorporated by reference. The present application also claims priority to Korean Patent Application Nos. 10-2024-0127487 and 10-2024-0127488 filed on Sep. 20, 2024, which in turn claim priority to Korean Patent Application Nos. 10-2023-0129140 and 10-2023-0129158 filed on Sep. 26, 2023, the entire contents of which are incorporated herein by reference.

### TECHNICAL FIELD

The present disclosure relates to an oil purification apparatus for removing fine moisture and impurities in oil.

### BACKGROUND ART

In petroleum and mineral oil products, and various organic and inorganic oils, the mixing of moisture and impurities occurs for various reasons, and the resulting problems are important industrial challenges. Brine is mixed during crude oil mining, or impurities such as moisture, organic matter, solid matter, and various biological substances are included in the process of extracting organic oils from plants or animals. On the other hand, inorganic oils are composed of petrochemical components and contain moisture, brine, solid matter, organic matter, and the like as impurities.

Brine becomes mixed due to the phenomenon in which water with a higher specific gravity exists in the lower layer of underground geological strata where crude oil is accumulated, and is subsequently extracted along with the crude oil. Moisture is primarily removed during the crude oil purification process, but fine droplets or impurities in the form of ions are not completely removed.

In the purification process, moisture is evaporated through separation using a specific gravity difference and high-temperature heating. However, during this process, impurities such as sodium (Na+) and chlorine (Cl−) ions still remain and must be removed through an additional washing process. The washing process uses a method of adding deionized water (DI water) and vigorously stirring to allow impurities to move into the deionized water. However, even in this process, it is difficult to completely remove moisture, so an electrostatic method using a high-voltage DC electric field is additionally applied to remove fine moisture.

Despite these complex purification processes, complete moisture removal is difficult. In particular, in the aviation and space industries, strict moisture management is required, and even fine moisture may cause combustion imbalance or clogging of pumps and filters, resulting in problems.

In addition, in order to increase the purity of organic and inorganic oils, solid impurities are removed using sedimentation or a specific gravity difference. Thereafter, fine solid matters are removed through a mechanical filter. This filtering process may use various structures depending on the characteristics of the oil and the solid matter particle size, and a mesh made of polymer materials or metal may be used.

After the removal of solid matter, ionic components such as sodium (Na) and potassium (K) and water remain as impurities. To solve this, an additional washing process is introduced, and using deionized water, the impurities are removed along with the water.

After the purification process, a separation method based on the difference in specific gravity is applied to separate the remaining water and oil. In this process, oil is located at the top and water at the bottom, achieving separation. To increase separation efficiency, the oil is heated to reduce viscosity, and the remaining moisture is minimized by evaporating the moisture beyond the boiling point of water.

This method consumes a lot of energy and requires explosion-proof management due to oil deterioration and heating. In addition, costs are incurred to cool the heated oil.

The introduction of additional equipment to improve purification efficiency or an explosion-proof device for explosion protection increases the complexity and cost of the equipment configuration, and operating costs also increase. In particular, since these processes are only highly economical in large-scale facilities, they are difficult to apply in small-scale industries.

Therefore, there is a demand for the development of oil purification technology that may efficiently remove moisture and fine solid impurities simultaneously using low energy, even in small-scale industrial sites, has a simple structure, and is easy to

### DISCLOSURE

The present disclosure attempts to provide a technology for efficiently removing fine moisture and impurities with low energy consumption and a simple structure instead of a high-cost complex moisture and impurity removal process. To solve the problems of the oil purification process, the present invention disclosure attempts to provide an apparatus for removing fine moisture and impurities contained in oil, which may replace existing complex purification processes through low energy consumption and a simple structure and may be utilized even in small-scale application fields.

However, the objective of the present disclosure is not limited to the aforementioned one, and may be extended in various ways within the spirit and scope of the present disclosure.

An oil purification apparatus according to one embodiment may comprise: a housing having a purification space formed therein; an inlet formed at one side of the housing and connected to the purification space, into which oil containing at least one of moisture and impurities is introduced; a first outlet formed at an upper side of the housing, through which oil purified in the purification space is discharged; a second outlet formed at a lower side of the housing, through which at least one of the moisture and impurities separated from the oil is discharged; and a filter unit disposed between the inlet and the first outlet in the purification space to remove at least one of the moisture and impurities contained in the oil, wherein the oil introduced through the inlet is configured to pass through the filter unit and be discharged through the first outlet.

The oil purification apparatus may further comprise a partition plate disposed in the purification space and dividing the purification space into a filter space in which the filter unit is disposed and a discharge space connected to the second outlet, wherein a connection hole connecting the filter space and the discharge space and through which moisture may be introduced may be formed in a portion of the partition plate between the filter unit and the inlet.

The filter unit may be inclined at an angle of 25° to 85° with respect to a top surface of the partition plate.

The inlet may be formed on the upper side or the lower side of the housing.

The filter unit may be arranged in a direction from the inlet toward the first outlet, and the mesh of the arranged filter unit may become denser as it approaches the first outlet.

The filter unit has a mesh count in a range from 100 to 3000 the filter unit has a mesh count in a range from 100 to 3000.

The filter unit may comprise a plurality of filter members disposed at intervals between the inlet and the first outlet.

Among the plurality of filter members, a second filter space between a first filter member and a second filter member, and a third filter space between the second filter member and a third filter member, may be connected to the second outlet.

The oil purification apparatus may further comprise a partition wall disposed in the purification space and positioned between the inlet and the second outlet, wherein the partition wall is spaced apart from the bottom of the purification space and connected to the first filter member, and the second filter space and the third filter space may be connected to the second outlet through a flow passage between the partition wall and the inner surface of the housing.

The bottom of the purification space may be inclined from one side toward the other side, and the second outlet may be connected to the other side of the bottom of the purification space.

The bottom of the purification space may be inclined at an angle of 15° to 25° with respect to a virtual horizontal line.

The oil purification apparatus may further comprise an inclination adjusting unit installed on the housing and which may set an inclination of the filter unit.

The filter unit is arranged in a direction from the inlet toward the first outlet to form a multi-layer, and the inclination adjusting unit may be installed for each of the arranged filter units.

The inclination adjusting unit may comprise a hinge shaft protruding from the filter unit and rotatably coupled to the housing, a lever connected to the hinge shaft and rotatably installed on the housing, and a locking mechanism formed between the lever and an outer circumference of the housing and to which the rotating lever is locked in steps.

The oil purification apparatus may further comprise a shielding member connecting the filter unit and the circumference of the purification space and blocking moisture from passing between the filter unit and the circumference of the purification space, wherein the shielding member may be folded and unfolded according to the rotation of the filter unit.

The filter unit may be a superhydrophobic filter.

The oil purification apparatus may further comprise a storage unit connected to the inlet and that may store oil containing at least one of the moisture and impurities.

The storage unit may comprise a storage housing having a storage space formed therein, an inlet pipe formed on the storage housing and supplying oil containing at least one of the moisture and impurities to the storage space, a level control valve positioned in the storage space, installed on the inlet pipe, and adjusting a liquid level of the storage space, and a supply pipe formed on the storage housing, connecting the storage space and the purification space, and supplying the oil containing at least one of the moisture and impurities to the purification space.

The lower end of the inlet pipe and the center of the supply pipe may be aligned with each other, and the height of the center of the inlet may be lower than the height of the center of the supply pipe with respect to the bottom surface of the housing, so that the oil containing at least one of moisture and impurities in the storage space may be introduced into the purification space by gravity.

The oil purification apparatus may further comprise a pre-treatment unit connected to the inlet pipe and that may heat oil containing at least one of moisture and impurities.

According to an oil purification apparatus according to an embodiment, since the filter unit is composed of a superhydrophobic material, it maximizes the difference in interfacial tension and contact angle between oil and moisture. This enables efficient blocking of fine droplets at the filter unit and separation of fine moisture existing in the oil, thereby improving fine moisture removal efficiency.

According to an oil purification apparatus according to an embodiment, since the filter units are arranged and the meshes are sequentially and densely arranged, it may respond to moisture and impurity particles of various sizes, thereby improving the efficiency of removing moisture and impurities.

According to an oil purification apparatus according to an embodiment, since the filter unit is arranged in an inclined manner, the aggregation of water droplets according to the flow of oil is promoted, and as the oil naturally passes through, the water droplets are caused to fall downwards without sticking to the filter, thereby preventing clogging of the filter.

According to an oil purification apparatus according to an embodiment, since the separated water naturally collects at the bottom due to the difference in specific gravity and is automatically discharged, even if the filter unit is used for a long period, it is less likely to be clogged or damaged by water, which has the effect of reducing maintenance costs and lengthening the lifespan of the filter.

According to an oil purification apparatus according to an embodiment, an optimal filter unit may be provided for various types of oil such as light oil and heavy oil by the mesh and inclination of a filter unit. Accordingly, there is an effect that may secure high compatibility for various oils by adjusting the angle and structure of the filter unit according to the characteristics of the oil.

According to an oil purification apparatus according to an embodiment, since the inclination of the filter unit may be easily adjusted through the inclination adjusting unit, an operator may adjust the inclination of the filter unit without a separate tool, thereby improving usability as the inclination of the filter unit may be variously set according to the type of oil.

According to an oil purification apparatus according to an embodiment, since the shielding member prevents moisture from passing between the filter unit and the purification space, it has the effect of maintaining moisture removal efficiency.

According to an oil purification apparatus according to an embodiment, the filter units are arranged to form a multi-layer, and since the inclination adjusting unit and the shielding member are installed for each separation filter unit, the inclinations of the multi-layer filter units may be varied, which has the effect of increasing moisture and oil separation efficiency.

According to an oil purification apparatus according to an embodiment, since unrefined oil is supplied to the purification housing using self-weight, no pump facility is required. As a result, facility installation costs and operating costs are saved, and energy consumption is reduced.

According to an oil purification apparatus according to an embodiment, by pre-heating the oil to 25° C. to 70° C., viscosity may be reduced, moisture removal efficiency may be increased, while the generation of unnecessary oil vapor may be minimized. This brings about an energy saving effect, and has the effect that processing costs may be lowered while maintaining the quality of fuel oil.

According to an oil purification apparatus according to an embodiment, the quality of fuel oil (gasoline, diesel, etc.) may be improved through removal of fine moisture and impurities, and oil from which moisture and impurities have been removed has increased combustion efficiency, reduced corrosion or wear in engines and equipment, thereby improving product performance and reducing maintenance costs.

However, the effects of the embodiments are not limited to the above-mentioned effects and may obviously be expanded in various ways without departing from the spirit and scope of the present invention.

### BRIEF DESCRIPTION OF DRAWINGS

FIG. 1 is a schematic diagram illustrating g a fine moisture removal apparatus according to an embodiment.

FIG. 2 is a schematic diagram illustrating a fine moisture removal apparatus according to another embodiment.

FIG. 3 is a schematic diagram illustrating an impurity removal apparatus for removing impurities contained in oil according to another embodiment.

FIG. 4 is an enlarged view showing the removal unit of FIG. 3.

### MODE FOR THE INVENTION

Hereinafter, embodiments of the present disclosure will be described in detail with reference to the attached drawings so that a person of ordinary skill in the art to which the present invention belongs may easily practice it. In the drawings, parts irrelevant to the description are omitted in order to clearly describe the present invention, and the same reference numeral is assigned to the same or similar elements throughout the specification. In addition, in the attached drawings, some elements are exaggerated, omitted, or schematically illustrated, and the size of each element does not entirely reflect the actual size.

The attached drawings are only intended to facilitate understanding of the embodiments disclosed in the present specification, and the technical idea disclosed in the present specification is not limited by the attached drawings, and it should be understood to comprise all modifications, equivalents, or substitutes falling within the spirit and technical scope of the present invention.

Terms including ordinal numbers such as first and second may be used to describe various elements, but the elements are not limited by the terms. These terms are only used for the purpose of distinguishing one element from another.

In addition, when a part such as a layer, film, region, or plate is said to be “on” or “above” another part, this includes not only the case where it is “directly on” the other part but also the case where another part is present in between. Conversely, when a part is said to be “directly on” another part, it means that no other part is present in between. In addition, being “on” or “above” a reference part means being located above or below the reference part, and does not necessarily mean being located “on” or “above” toward the opposite direction of gravity.

Throughout the specification, terms such as “comprise” or “have” are intended to designate the presence of features, numbers, steps, or operations, elements, parts or combinations thereof described in the specification, and should be understood not to exclude the possibility of the presence or addition of one or more other features, numbers, steps, operations, elements, parts or combinations thereof. Therefore, when a part “comprise” an element, this means that it may further comprise other elements rather than excluding other elements unless specifically stated otherwise.

In addition, throughout the specification, “in a plan view” means when the target part is viewed from above, and “in a cross-sectional view” means when a vertically cut cross-section of the target part is viewed from the side.

Throughout the specification, when a part is said to be “coupled” with another part, this includes not only the case where they are “directly or physically coupled” but also the case where they are “indirectly or non-contact coupled” with another element interposed therebetween.

In addition, throughout the specification, when it is said to be “connected,” this does not only mean that two or more elements are directly connected, but may also mean that two or more elements are indirectly connected through another element, that they are physically connected as well as electrically connected, or that they are integral even if referred to by different names depending on their location or function.

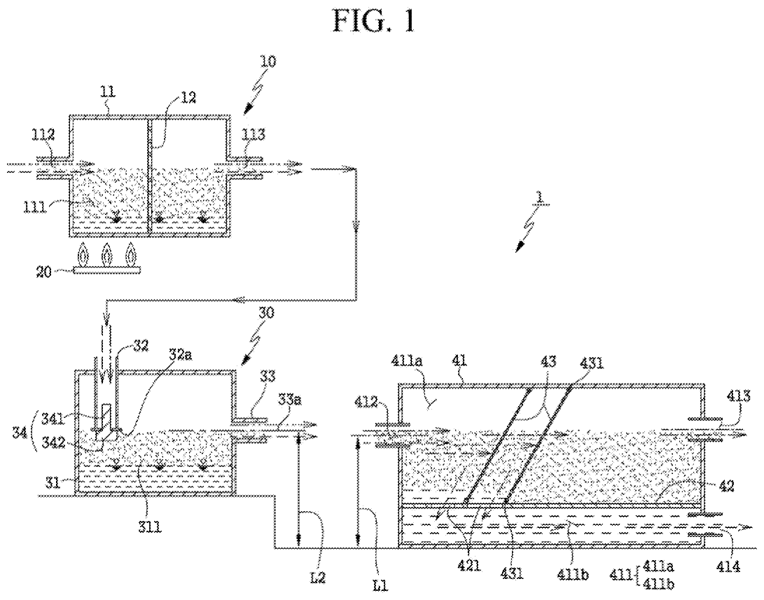

FIG. 1 is a schematic diagram illustrating a fine moisture removal apparatus as an oil purification apparatus according to an embodiment.

Referring to FIG. 1, the fine moisture removal apparatus 1 according to the present embodiment comprises a pre-treatment unit 10, a storage unit 30, and a removal unit, and efficiently removes fine moisture with low energy consumption and a simple structure instead of a high-cost complex moisture removal process. The removal unit comprises a separation housing 41, a separation filter unit 43, and a partition plate 42.

The pre-treatment unit 10 comprises a pretreatment housing 11 and a filtering member 12, and reduces viscosity to facilitate the flow of oil.

A pretreatment space 111 is formed inside the pretreatment housing 11. A pretreatment inlet 112, through which oil containing moisture is introduced, is formed at one side of the pretreatment housing 11, and a pretreatment outlet 113, through which pretreated oil containing moisture is discharged, is formed at the other side.

The oil containing moisture may be introduced into the pretreatment space 111 through the pretreatment inlet 112, and the oil containing moisture exceeding the capacity of the pretreatment space 111 may be discharged through the pretreatment outlet 113. The oil containing moisture may be introduced into the pretreatment housing 11 by self-weight or pump pressure.

A heating means 20 such as a burner or heater is disposed in the pretreatment housing 11. The oil containing moisture in the pretreatment space 111 may be heated by the heating means 20. The heating temperature may be 20° C. to 70° C. Heating the oil containing moisture to 20° C. lowers the heating efficiency, and heating it beyond 70° C. increases the amount of oil vapor evaporated from the oil, causing safety risks, and the superhydrophobic performance may be lowered, which may lead to a decrease in moisture removal efficiency. The heating temperature may vary depending on the type of oil. For example, in the case of heavy oil, it may be at a level of 60° C., and in the case of light oil, it may be less than 30° C. Through heating, the oil may maintain a viscosity suitable for purification.

A filtering member 12 is installed inside the pretreatment housing 11. The filtering member 12 has a mesh structure. The filtering member 12 may have a mesh count in a range from 300 to 2000.

The filtering member 12 may remove solid foreign substances contained in the oil. The filtering member 12 may be made of metal.

The oil containing moisture heated in the pre-treatment unit 10 has a reduced viscosity and may be discharged through the pretreatment outlet 113 and flow to the storage unit 30.

However, the pre-treatment unit 10 may be omitted.

The storage unit 30 comprises a storage housing 31, an inlet pipe 32, a level control valve 34, and a supply pipe 33, and receives and stores oil containing moisture supplied from the pre-treatment unit 10 and supplies it to the separation housing 41. At this time, the storage unit 30 may primarily separate moisture and oil using the difference in specific gravity between moisture and oil.

A storage space 311 is formed inside the storage housing 31. The moisture-containing oil from the pre-treatment unit 10 may be introduced and stored in the storage space 311. At this time, the oil introduced from the pre-treatment unit 10 may flow and be introduced by self-weight without using a pump.

The inlet pipe 32 is installed on the top surface of the storage housing 31. The upper portion of the inlet pipe 32 protrudes from the top surface of the storage housing 31 and the lower portion is in the storage space 311. The lower end 32a of the inlet pipe 32 is spaced apart from the bottom of the storage space 311.

The inlet pipe 32 is connected to the pretreatment outlet 113 of the pre-treatment unit 10. Accordingly, the oil containing moisture from which foreign substances have been removed and whose viscosity has been reduced may be introduced into the storage space 311 through the inlet pipe 32 and stored.

The supply pipe 33 is formed on the upper portion of side surface of the storage housing 31. The supply pipe 33 has a predetermined diameter dimension. The center 33a of the supply pipe 33 and the lower end 32a of the inlet pipe 32 are aligned with each other to be located on the same line. The moisture-containing oil in the storage space 311 may be discharged through the supply pipe 33 to flow to the removal unit.

The level control valve 34 is coupled to the inlet pipe 32 in the storage space 311. The level control valve 34 has a float structure. The level control valve 34 is located outside the inlet pipe 32 and has an outer circumferential diameter dimension larger than the outer circumferential diameter dimension of the inlet pipe 32, and comprises a valve body 342 that may contact or be separated from the lower end 32a of the inlet pipe 32, and a rod 341 protruding from the valve body 342 and inserted into the inlet pipe 32 to guide when the valve body 342 contacts or separates from the inlet pipe 32. The outer circumference of the rod 341 is spaced apart from the inner circumference of the inlet pipe 32 at an interval. The rod 341 prevents the valve body 342 from leaving the inlet pipe 32 when the valve body 342 separates from the inlet pipe 32.

Such a level control valve 34 may be positioned on the water surface of the storage space 311. When the water level rises, the valve body 342 may block the lower end 32a of the inlet pipe 32. Oil containing moisture cannot be introduced into the storage space 311 from the pre-treatment unit 10. When the oil containing moisture is discharged through the supply pipe 33, the water level of the storage space 311 is lowered, and the valve body 342 may separate from the lower end 32a of the inlet pipe 32. When the lower end 32a of the inlet pipe 32 is opened, the oil containing moisture from the pre-treatment unit 10 may be introduced into the storage space 311.

Since the center of the supply pipe 33 and the lower end 32a of the inlet pipe 32 are aligned with each other to be located on the same line, the valve body 342 and the lower end 32a of the inlet pipe 32 are always separated by a constant interval, so that the oil containing moisture may be continuously introduced into the storage space 311 at a constant flow rate.

Meanwhile, moisture (water) and oil do not mix with each other because they have different properties. Accordingly, moisture and oil form layers in the storage space 311, whereby the oil separates distinctly and floats above the moisture.

Therefore, moisture and oil are primarily separated by the density difference in the storage unit 30, and the oil may be discharged to the outside of the storage housing 31 through the supply pipe 33. At this time, micro-moisture (micro water or micro droplet) may not be completely separated and may be discharged while being included in the oil. In addition, a drainage hole (not shown) for draining moisture is formed at the lower side of the storage housing 31.

However, the storage unit 30 may be omitted.

A separation space 411 in which oil and moisture are separated is formed inside the separation housing 41. An inlet 412 is formed at the upper portion of one side of the separation housing 41 and is connected to the supply pipe 33, into which oil containing moisture is introduced. The supply pipe 33 and the inlet 412 have the same diameter dimension. The center height L1 of the inlet 412 is lower than the center height L2 of the supply pipe 33 with respect to the bottom surface of the separation housing 41. Accordingly, due to the height difference between the supply pipe 33 and the inlet 412, the oil containing moisture discharged from the supply pipe 33 may flow to the inlet 412 and be introduced into the separation space 411 even without pump pressure.

An oil outlet 413 is formed at the upper portion of the other side of the separation housing 41, through which oil separated from moisture in the separation space is discharged. A water outlet 414 is formed at the lower portion of the other side of the separation housing 41, through which moisture separated from the oil is discharged.

The partition plate 42 is disposed close to the bottom of the separation space 411 inside the separation housing 41. The partition plate 42 partitions the separation space 411 into upper and lower portions. Accordingly, the separation space 411 is partitioned into a filter space 411a in which moisture and oil are separated and a discharge space 411b into which moisture separated from the oil may be introduced. A connection hole 421 connecting the filter space 411a and the discharge space 411b is formed in the partition plate 42.

The filter space 411a is connected to the inlet 412 and the oil outlet 413, and the discharge space 411b is connected to the water outlet 414. Oil containing moisture is introduced into the filter space 411a through the inlet 412, oil separated from moisture in the filter space 411a is discharged to the outside of the separation housing 41 through the oil outlet 413, and moisture is introduced into the discharge space 411b through the connection hole 421 and may be discharged to the outside of the separation housing 41 through the water outlet 414.

The separation filter unit 43 is disposed in the filter space 411a and is positioned between the partition plate 42 and the internal top surface of the separation housing 41. The separation filter unit 43 is disposed adjacent to the connection hole 421. The portion of the partition plate 42 where the connection hole 421 is formed is the portion between the separation filter unit 43 and the inlet 412. The separation filter unit 43 is disposed to be inclined at an angle of 25° to 85° with respect to the top surface of the partition plate 42. Here, if the oil is light oil, the separation filter unit 43 may be inclined by 25° to 45°, and if the oil is heavy oil, the separation filter unit 43 may be inclined by 75° to 85°. The inclination of the separation filter unit 43 may vary depending on the type of oil.

Due to the inclination of the separation filter unit 43, moisture separated in the process of oil containing moisture passing through the separation filter unit 43 gradually aggregates according to the flow rate, and is effectively introduced into the discharge space 411b through the connection hole 421.

The separation filter unit 43 may be made of polyvinylidene fluoride (PVDF), polytetrafluoroethylene (PTFE), silicon nanoparticles, fluoropolymer, silica nanoparticles, graphene-based materials, polydimethylsiloxane (PDMS), carbon nanotubes, or the like. Accordingly, the separation filter unit has a superhydrophobic property.

The separation filter unit 43 has a mesh structure having micropores, and the mesh number may be 100 to 3000.

The separation filter unit 43 is arranged along the longitudinal direction of the partition plate 42 to form a multi-layer. The number of separation filter units 43 may vary depending on the design of the fine moisture removal apparatus 1. When separation filter units 43 are arranged, the mesh number of the separation filter unit 43 close to the inlet 412 may be 100, and the mesh number of the separation filter unit 43 close to the oil outlet 413 may be 3000. That is, the mesh of the arranged separation filter units 43 becomes denser as it gets further from the inlet 412.

The arrangement of the separation filter unit 43 may respond to the particle size of various fine moisture, specifically micro droplets, existing in the oil. Since separation filter units 43 with different meshes are arranged in a multi-layer, the moisture separation efficiency is improved.

Meanwhile, a coupling groove 431 to which the edges of the separation filter unit 43 are coupled is formed on the internal top surface and circumference of the partition plate 42 and the separation housing 41. The separation filter unit 43 may be detachably coupled to the coupling groove 431 in a sliding manner.

Oil containing moisture introduced into the filter space 411a through the inlet 412 contacts the separation filter unit 43. At this time, due to the superhydrophobic property of the separation filter unit 43 and differences in interfacial tension and contact angle, oil passes through while moisture may not pass through. Since the oil containing moisture flows by self-weight (gravity), no more pressure than necessary is applied to the filter space 411a.

Oil that has passed through the separation filter unit 43 may be discharged to the outside of the separation housing 41 through the oil outlet 413. And moisture that has not passed through the separation filter unit 43 forms a layer with the oil in the filter space 411a and may be introduced into the discharge space 411b through the connection hole 421 guided by the inclined separation filter unit 43. Moisture in the discharge space 411b may be discharged to the outside of the separation housing 41 through the water outlet 414.

The following describes the operation of the fine moisture removal apparatus 1 described above.

The pre-treatment unit 10 heats the oil containing moisture introduced into the pretreatment space 111 to a temperature in the range of 25° C. to 70° C. At this time, heavy oil generally used for fuel is at a level of 60° C., and light oil may be at a temperature of 20° C. or higher. The heating temperature range may achieve sufficient viscosity reduction for moisture removal for light oil and heavy oil and may minimize the generated oil vapor.

The oil containing moisture, heated and pretreated in the pretreatment space 111, is introduced into the storage space 311 by self-weight without using pump pressure. The oil containing moisture in the storage space 311 is introduced into the filter space 411a through the inlet 412 and contacts the separation filter unit 43 having superhydrophobic characteristics. Due to the differences in interfacial tension and contact angle at the separation filter unit 43, oil passes through the separation filter unit 43 and moisture cannot pass through. That is, the separation filter unit 43 has a function of blocking moisture through the superhydrophobic mesh, and the blocked moisture is collected downward by the specific gravity difference and then introduced into the discharge space 411b through the connection hole 421 and discharged to the outside of the separation housing 41 through the water outlet 414.

Therefore, by forming the separation filter unit 43 in a multi-layer, moisture (fine water droplets) may be prevented from permeating through the separation filter unit 43 due to the flow of oil.

In addition, by disposing the separation filter unit 43 in an inclined manner, the fine moisture collected within the separation filter unit 43 is naturally introduced into the discharge space 411b through the connection hole 421 via the inclination, and this configuration enables its discharge, thereby improving the fine moisture removal efficiency.

In addition, the fine moisture removal efficiency is increased as the untreated input oil containing moisture naturally moves.

In addition, in the process of the oil containing moisture passing through the inclined separation filter unit (43), moisture particles may be gradually aggregated and discharged according to the moisture removed and the flow rate.

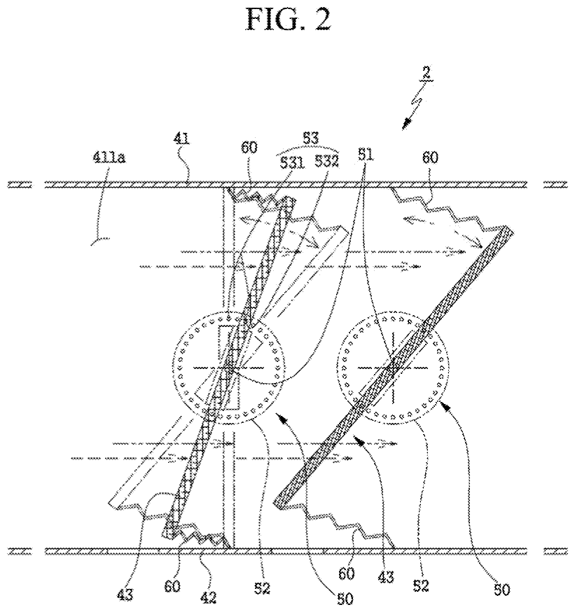

Hereinafter, a fine moisture removal apparatus according to another embodiment will be described with reference to FIG. 2. FIG. 2 is a schematic diagram illustrating a fine moisture removal apparatus according to another embodiment.

The fine moisture removal apparatus shown in FIG. 2 has substantially the same configuration as the embodiment described with reference to FIG. 1. Hereinafter, configurations that are different will be described, the same reference numerals will be used for the same configurations, and configurations that are not separately described may be configured similarly to the embodiment shown in FIG. 1.

Referring to FIG. 2, the fine moisture removal apparatus 2 according to the present embodiment may mostly have the components of the embodiment described with reference to FIG. 1, and may further comprise an inclination adjusting unit 50 and a shielding member 60.

The inclination adjusting unit 50 comprises a hinge shaft 51, a lever 52, and a locking mechanism 53 and is installed on the separation housing 41 to rotate the separation filter unit 43 to set the inclination of the separation filter unit 43. The inclination adjusting unit 50 and the shielding member 60 may be disposed for each of the separation filter units 43 that are arranged to form a multi-layer. Accordingly, the inclination of the multi-layer separation filter units 43 may be varied using the inclination adjusting unit 50, which has the effect of increasing the separation efficiency of moisture and oil. In the case of this embodiment, the coupling groove 431 to which the separation filter unit 43 is coupled is omitted.

The hinge shaft 51 protrudes from both sides of the separation filter unit 43 and is coupled to the separation housing 41. A bearing or the like is installed between the hinge shaft 51 and the separation housing 41, which may promote the rotation of the hinge shaft 51. An airtight structure is provided between the hinge shaft 51 and the bearing, and between the bearing and the separation housing 41.

The lever 52 is rotatably disposed on one side outer surface of the separation housing 41 and is coupled with the hinge shaft 51 on one side. The lever 52 may be held by an operator. When the lever 52 is rotated, the separation filter unit 43 may rotate in the filter space 411a through the hinge shaft 51.

The locking mechanism 53 is formed on the inner surface of the lever 52 and the outer surface of the separation housing 41. The locking mechanism 53 comprises an engaging groove 531 formed in the separation housing 41 and an engaging protrusion 532 formed in the lever 52. The engaging groove 531 is arranged along the circumferential direction with respect to the hinge shaft 51. The engaging protrusion 532 protrudes from the lever 52 and is inserted into the engaging groove 531. The engaging groove 531 is formed in a semi-circular shape and the engaging protrusion 532 is formed in a hemispherical shape corresponding to the engaging groove 531. When the lever 52 is rotated, the engaging protrusion 532 may be locked in steps into the engaging groove 531. Accordingly, as the engaging protrusion 532 is locked in the engaging groove 531, the separation filter unit 43 may maintain an inclined state.

The shielding member 60 may block moisture and oil from flowing between the edge of the separation filter unit 43 and the circumference of the filter space 411a. One end of the shielding member 60 is connected to the circumference of the filter space 411a and the other end is connected to the edge of the separation filter unit 43. The shielding member 60 has a folding structure and may be folded and unfolded according to the rotation of the separation filter unit 43. The shielding member 60 may be made of the same material as the separation filter unit 43.

Therefore, according to the present embodiment, since the inclination of the separation filter unit 43 may be easily adjusted through the lever 52, an operator may adjust the inclination of the separation filter unit 43 without a separate tool, and the inclination of the separation filter unit 43 may be set in various ways according to the type of oil, thereby improving usability.

In addition, since the shielding member 60 prevents moisture from passing between the separation filter unit 43 and the filter space 411a, it has the effect of maintaining the moisture removal efficiency.

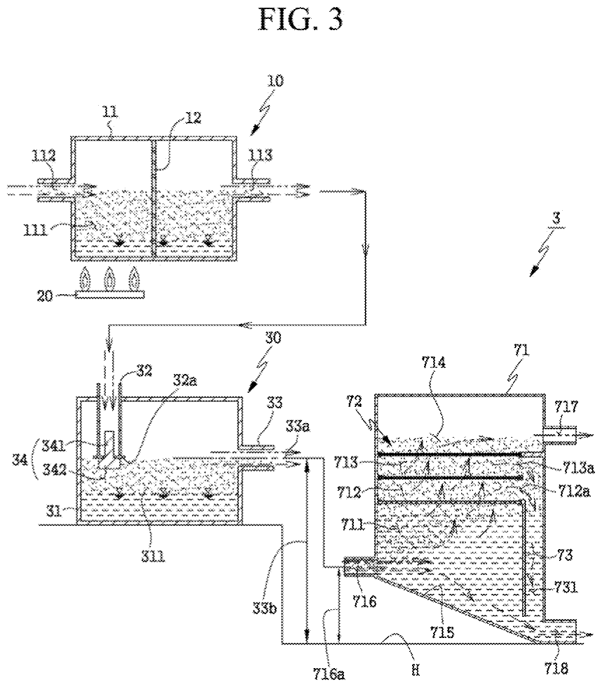

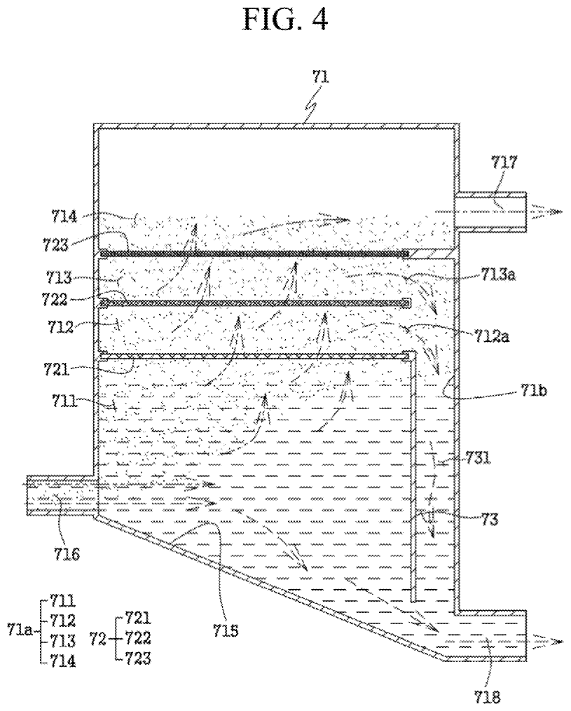

Hereinafter, with reference to FIGS. 3 and 4, an impurity removal apparatus for removing impurities contained in oil, which serves as an oil purification apparatus according to another embodiment, will be described in more detail. FIG. 3 is a schematic diagram illustrating an impurity removal apparatus for removing impurities contained in oil according to another embodiment, and FIG. 4 is an enlarged view illustrating the removal unit of FIG. 3.

Referring to FIG. 3, the impurity removal apparatus 3 for removing impurities contained in oil according to the present embodiment comprises a pre-treatment unit 10, a storage unit 30, and a removal unit, and replaces the existing complex purification process through low energy consumption and a simple structure. The removal unit comprises a removal housing 71, a filter unit 72, and a partition wall 73.

The pre-treatment unit 10 comprises a pretreatment housing 11 and a filtering member 12, and reduces viscosity to facilitate flow by applying oil.

A pretreatment space 111 is formed inside the pretreatment housing 11. A pretreatment inlet 112, through which oil containing impurities (moisture, brine, solid matter, organic and inorganic substances, etc.) is introduced, is formed at one side of the pretreatment housing 11. A pretreatment outlet 113, through which pretreated oil containing impurities is discharged, is formed at the other side of the pretreatment housing 11.

The oil containing impurities may be introduced into the pretreatment space 111 through the pretreatment inlet 112, and the oil containing impurities exceeding the capacity of the pretreatment space 111 may be discharged through the pretreatment outlet 113. The oil containing impurities may be introduced into the pretreatment housing 11 by self-weight or pump pressure.

A heating means 20 such as a burner or heater is disposed in the pretreatment housing 11. The oil containing impurities in the pretreatment space 111 may be heated by the heating means 20. The heating temperature may be 20° C. to 70° C. Heating the oil containing impurities to 20° C. lowers the heating efficiency, and heating it beyond 70° C. increases the amount of oil vapor evaporated from the oil, causing safety risks, and may lower superhydrophobic performance, which may lead to a decrease in moisture removal efficiency. The heating temperature may vary depending on the type of oil. The heating temperature may vary depending on the type of oil. For example, in the case of heavy oil, it may be at a level of 60° C., and in the case of light oil, it may be less than 30° C. Through heating, the oil may maintain a viscosity suitable for purification.

A filtering member 12 is detachably installed inside the pretreatment housing 11. The filtering member 12 is coupled to the pretreatment housing 11 in a sliding manner. The filtering member 12 has a mesh structure. The mesh of the filtering member 12 may be 300 to 2000.

The filtering member 12 may remove solid foreign substances contained in the oil. The filtering member 12 may be made of metal.

The oil containing impurities heated in the pre-treatment unit 10 has a reduced viscosity and may be discharged through the pretreatment outlet 113 and may flow to the storage unit 30.

However, the pre-treatment unit 10 may be omitted.

The storage unit 30 includes a storage housing 31, an inlet pipe 32, a level control valve 34, and a supply pipe 33, and receives and stores oil containing impurities supplied from the pre-treatment unit 10 and supplies it to the separation housing 41. At this time, the storage unit 30 may primarily separate moisture, which is an impurity contained in the oil, from the oil by utilizing the difference in specific gravity between the moisture and the oil.

A storage space 311 is formed inside the storage housing 31. The oil containing impurities from the pre-treatment unit 10 may be introduced and stored in the storage space 311. At this time, the oil introduced from the pre-treatment unit 10 may flow and be introduced by gravity without using a pump.

The inlet pipe 32 is installed on the top surface of the storage housing 31. The upper portion of the inlet pipe 32 protrudes from the top surface of the storage housing 31 and the lower portion is in the storage space 311. The lower end 32a of the inlet pipe 32 is spaced apart from the bottom of the storage space 311.

The inlet pipe 32 is connected to the pretreatment outlet 113 of the pre-treatment unit 10. Accordingly, the oil containing impurities from which foreign substances have been removed and whose viscosity has been reduced may be introduced into the storage space 311 through the inlet pipe 32 and stored.

The supply pipe 33 is formed on the upper portion of side surface of the storage housing 31. The supply pipe 33 has a predetermined diameter dimension. The center 33a of the supply pipe 33 and the lower end 32a of the inlet pipe 32 are aligned with each other to be located on the same line. The oil containing impurities in the storage space 311 may be discharged through the supply pipe 33 to flow to the removal unit.

The level control valve 34 is coupled to the inlet pipe 32 in the storage space 311. The level control valve 34 has a float structure. The level control valve 34 is located outside the inlet pipe 32 and has an outer diameter larger than the outer diameter of the inlet pipe 32, and comprises a valve body 342 that may contact or be separated from the lower end 32a of the inlet pipe 32, and a rod 341 that protrudes from the valve body 342, is inserted into the inlet pipe 32, and guides when the valve body 342 contacts or separates from the inlet pipe 32. The outer circumference of the rod 341 is spaced apart from the inner circumference of the inlet pipe 32 at an interval. The rod 341 prevents the valve body 342 from leaving the inlet pipe 32 when the valve body 342 separates from the inlet pipe 32.

Such a level control valve 34 may be positioned on the water surface of the storage space 311. When the water level rises, the valve body 342 may block the lower end 32a of the inlet pipe 32. Oil containing impurities cannot be introduced into the storage space 311 from the pre-treatment unit 10. When the oil containing impurities is discharged through the supply pipe 33, the water level of the storage space 311 is lowered, and the valve body 342 may separate from the lower end 32a of the inlet pipe 32. When the lower end 32a of the inlet pipe 32 is opened, the oil containing impurities from the pre-treatment unit 10 may be introduced into the storage space 311.

Since the center of the supply pipe 33 and the lower end 32a of the inlet pipe 32 are aligned with each other to be located on the same line, the valve body 342 and the lower end 32a of the inlet pipe 32 are always separated by a constant interval, so that the oil containing impurities may be continuously introduced into the storage space 311 at a constant flow rate by gravity.

Meanwhile, moisture (water) and oil do not mix with each other due to their different properties. Accordingly, moisture and oil form layers in the storage space 311, whereby the oil separates and floats above the moisture. A drainage hole (not shown) for draining moisture separated from the oil is formed at the bottom of the storage housing 31.

Therefore, moisture and oil are primarily separated by the density difference in the storage unit 30, and the oil may be discharged to the outside of the storage housing 31 through the supply pipe 33. At this time, micro-moisture (micro water or micro droplet) may not be completely separated and may be discharged while being included in the oil.

However, the storage unit 30 may be omitted.

Next, referring further to FIG. 4, a separation unit including a removal housing 71, a filter unit 72, and a partition wall 73 will be described.

A filter space 71a in which impurities and oil are separated is formed inside the removal housing 71. The filter space 71a has a predetermined volume.

An inlet 716 connected to the supply pipe 33 is formed on the lower portion of one side of the removal housing 71. The height 716a of the center of the inlet 716 is lower than the height 33b of the center of the supply pipe 33 with respect to the virtual horizontal line H. Accordingly, the oil containing impurities in the storage space 311 may be introduced into the filter space 71a through the inlet 716 by gravity.

An impurity outlet 718 connected to the filter space 71a is formed on the lower portion of the other side of the removal housing 71. Impurities in the filter space 71a may be discharged to the outside of the removal housing 71 through the impurity outlet 718. An oil outlet 717 connected to the filter space 71a is formed on the upper portion of the other side of the removal housing 71. Oil from which impurities have been removed may be discharged to the outside of the removal housing 71 through the oil outlet 717.

Meanwhile, the bottom 715 of the filter space 71a is inclined with respect to the virtual horizontal line H. Here, the virtual horizontal line H is a line parallel to the bottom surface of the removal housing 71. The bottom 715 of the filter space 71a is inclined by 15° to 25° with respect to the horizontal line H. The bottom 715 may be inclined by 20° with respect to the horizontal line H. If the bottom 715 is inclined at less than 15°, impurities accumulate within the filter space and drainage is not smooth. If the bottom 715 is formed beyond 25°, the oil introduced into the filter space 71a through the inlet 716 flows rapidly along the inclined bottom and may move quickly from the inlet 716 to the impurity outlet 718. Accordingly, filtering time is reduced, and impurity removal may be insufficiently achieved.

The partition wall 73 is disposed in the filter space 71a and is installed along the vertical direction of the removal housing 71. The partition wall 73 is close to the other inner side surface 71b of the filter space 71a. The upper portion of the partition wall 73 is separated from the internal top surface of the filter space 71a, and the lower portion is separated from the inclined bottom 715 of the filter space 71a. Both sides of the partition wall 73 are connected to the inner side surface of the removal housing 71. A flow passage 731 is formed between the partition wall 73 and the other inner side surface 71b.

The filter unit 72 comprises a first filter member 721, a second filter member 722, and a third filter member 723 and has a mesh structure having micropores. The mesh count of the first filter member 721, the second filter member 722, and the third filter member 723 may be 100 to 3000. For example, the mesh count of the first filter member 721 may be 100 mesh, the mesh count of the second filter member 722 may be 2000 mesh, and the mesh count of the third filter member 723 may be 3000 mesh.

These first to third filter members 721, 722, and 723 may be made of polyvinylidene fluoride (PVDF), polytetrafluoroethylene (PTFE), silicon nanoparticles, fluoropolymer, silica nanoparticles, graphene-based materials, polydimethylsiloxane (PDMS), carbon nanotubes, or the like. Accordingly, the first to third filter members 721, 722, and 723 have a superhydrophobic property.

The first filter member 721, the second filter member 722, and the third filter member 723 are sequentially disposed between the inlet 716 and the oil outlet 717 in the filter space 71a. The mesh size of the first filter member 721, the second filter member 722, and the third filter member 723 becomes denser from the inlet 716 toward the oil outlet 717. Due to the arrangement of the first filter member 721, the second filter member 722, and the third filter member 723, the filter space 71a is partitioned into first to fourth filter spaces 711 to 714.

The first filter member 721 is coupled to the circumference of the filter space 71a and the partition wall 73. A first filter space 711 is formed between the first filter member 721 and the inclined internal bottom 715 of the removal housing 71. The first filter space 711 is connected to the inlet 716 and the impurity outlet 718. Accordingly, the oil containing impurities from the storage unit 30 may be introduced into the first filter space 711. At this time, impurities of solid matter may move toward the impurity outlet 718 along the inclined bottom 715. The oil may fill up the first filter space 711 and may pass through the first filter member 721. At this time, moisture does not pass through the first filter member 721 due to the difference in contact angle on the superhydrophobic surface. Moisture in the first filter space 711 may be discharged through the impurity outlet 718. Here, fine moisture having particles smaller than the mesh of the first filter member 721 may pass through the first filter member 721 together with the oil.

The second filter member 722 is separated from the first filter member 721. A second filter space 712 is formed between the first filter member 721 and the second filter member 722. The circumference of the second filter member 722 is coupled along the inner circumference of the removal housing 71, but at least a portion is separated from the other side surface 71b, so that the second filter space 712 has a connection part 712a connected to the flow passage 731.

The oil that has passed through the first filter member 721 is introduced into the second filter space 712 and fills the second filter space 712. The oil passes through the second filter member 722. Fine moisture having particles smaller than the mesh of the second filter member 722 may pass through the second filter member 722. Fine moisture may be introduced into the flow passage 731 through the connection part 712a and may be drained through the impurity outlet 718.

The third filter member 723 is separated from the second filter member 722. The third filter member 723 is separated from the upper surface of the filter space 71a. The third filter member 723 is below the portion where the oil outlet 717 is formed. A third filter space 713 is formed between the third filter member 723 and the second filter member 722. The oil that has passed through the second filter member 722 fills the third filter space 713. A fourth filter space 714 is formed between the third filter member 723 and the upper surface of the filter space 71a. The third filter space 713 is connected to the flow passage 731 by a connection part 713a, and the fourth filter space 714 is connected to the oil outlet 717.

The oil in the third filter space 713 passes through the third filter member 723 and is introduced into the fourth filter space 714. The oil in the fourth filter space 714 may be discharged to the outside of the removal housing 71 through the oil outlet 717. In addition, fine moisture having particles smaller than the mesh of the third filter member 723 may be introduced into the flow passage 731 through the connection part 713a and drained through the impurity outlet 718.

By arranging filter members 721 to 723 with different meshes, the filter unit 72 may respond to the particle sizes of various fine moisture existing in the oil, i.e., micro droplets. Since filter members 721 to 723 with different meshes are arranged in a multi-layer, the moisture separation efficiency is improved.

Therefore, as the mesh of each filter member 721 to 723 becomes gradually denser, large moisture particles are filtered by the first filter member 721, medium-sized moisture particles are filtered by the second filter member 722, and the smallest fine moisture particles are filtered by the third filter member 723. Accordingly, the stepwise filtering method allows each filter member to effectively remove impurities of a specific size, thereby significantly improving the overall filtering efficiency.

The following describes the operation of the impurity removal apparatus 3 contained in the oil described above.

The pre-treatment unit 10 heats the oil containing impurities introduced into the pretreatment space 111 to a temperature in the range of 25° C. to 70° C. At this time, heavy oil generally used for fuel is at a level of 60° C., and light oil may be at a temperature of 20° C. or higher. The heating temperature range may achieve sufficient viscosity reduction for moisture removal in light oil and heavy oil and may minimize the generated oil vapor.

The oil containing impurities heated and pretreated in the pretreatment space 111 is introduced into the storage space 311 by self-weight without using pump pressure. The oil containing impurities in the storage space 311 is introduced into the first filter space 711 through the inlet 412.

Solid matter impurities contained in the oil introduced into the first filter space 711 flow through the inclined bottom 715 to the impurity outlet 718 and are discharged. Then, moisture and oil are separated in the first filter space 711 due to the specific gravity difference, so that moisture is located on the lower side and oil is located on the upper side.

Oil containing impurities continues to flow into the first filter space 711 through the inlet 716 and fills up the first filter space 711. The oil containing impurities passes through the first filter member 721. At this time, the oil passes through the first filter member 721 and is introduced into the second filter space 712. Moisture among the impurities cannot pass through the first filter member 721 due to its superhydrophobic property. However, fine moisture having particles smaller than the mesh of the first filter member 721 may be introduced into the second filter space 712 together with the oil. Moisture in the first filter space 711 may be discharged through the impurity outlet 718.

The oil in the second filter space 712 passes through the second filter member 722 and may be introduced into the third filter space 712. At this time, fine moisture having particles smaller than the mesh of the second filter member 722 may pass through the second filter member 722 together with the oil and may be introduced into the third filter space 712. Meanwhile, moisture that has not passed through the second filter member 722 may be discharged through the connection part 712a and the flow passage 731 to the impurity outlet 718.

The oil in the third filter space 713 passes through the third filter member 723 and is introduced into the fourth filter space 714. Meanwhile, moisture that has not passed through the third filter member 723 may be discharged through the connection part 713a and the flow passage 731 to the impurity outlet 718. Oil in the fourth filter space 714 is discharged to the outside of the removal housing 71 through the oil outlet 717.

Accordingly, instead of processing moisture particles of all sizes at once, large particles are filtered out first to reduce the burden on subsequent filter members, which has the effect of improving the overall durability of the filter members.

For reference, in the above description and drawings, the apparatus for removing fine moisture and impurities contained in oil of the present invention is not limited to separating oil and water. The apparatus for removing fine moisture and impurities contained in oil of the present invention should be interpreted as an apparatus that may separate oil (including mineral oil, organic oil, and inorganic oil) and all liquids using the specific gravity difference and the difference in contact angle on a superhydrophobic surface.

While embodiments of the present disclosure have been described above, the present disclosure is not limited thereto, and it is possible to perform various modifications within the scope of the claims, the detailed description, and the accompanying drawings, and it is natural that these modifications also fall within the scope of the present disclosure.

### DESCRIPTION OF SYMBOLS

1, 2: fine moisture removal apparatus
3: impurity removal apparatus
10: pre-treatment unit
11: pretreatment housing
111: pretreatment space
112: pretreatment inlet
113: pretreatment outlet
12: filtering member
20: heating means
30: storage unit
31: storage housing
311: storage space
32: inlet pipe
32a: lower end
33: supply pipe
33a: center
34: level control valve
341: rod
342: valve body
41: separation housing
411: separation space
411a: filter space
411b: discharge space
412: inlet
413: oil outlet
414: water outlet
42: partition plate
421: connection hole
43: separation filter unit
431: coupling groove
50: inclination adjusting unit
51: hinge shaft
52: lever
53: locking mechanism
531: engaging groove
532: engaging protrusion
60: shielding member
71: removal housing
71a: filter space
71b: other inner side surface
711: first filter space
712: second filter space
713: third filter space
712a, 713a: connection part
714: fourth filter space
715: bottom
716: inlet
716a: center height
717: oil outlet
718: impurity outlet
72: filter unit
721: first filter member
722: second filter member
723: third filter member
73: partition wall
731: flow passage
H: virtual horizontal line

1. An oil purification apparatus comprising:
a housing having a purification space formed therein;
an inlet formed at one side of the housing and connected to the purification space, into which oil containing at least one of moisture and impurities is introduced;
a first outlet formed at an upper portion of the other side of the housing, through which oil purified in the purification space is discharged,
a second outlet formed at a lower portion of the other side of the housing, through which the at least one of the moisture and impurities separated from the oil is discharged; and
a filter unit disposed between the inlet and the first outlet in the purification space to remove at least one of the moisture and impurities contained in the oil,
wherein the oil introduced through the inlet is configured to pass through the filter unit and be discharged through the first outlet.

2. The oil purification apparatus according to claim 1, further comprising:
a partition plate disposed in the purification space and dividing the purification space into a filter space in which the filter unit is disposed and a discharge space connected to the second outlet,
wherein a connection hole connecting the filter space and the discharge space and through which moisture may be introduced is formed in a portion of the partition plate between the filter unit and the inlet.

3. The oil purification apparatus according to claim 2, wherein the filter unit is inclined at an angle of 25° to 85° with respect to a top surface of the partition plate.

4. The oil purification apparatus according to claim 1, wherein the inlet is formed on the upper portion or lower portion of one side of the housing.

5. The oil purification apparatus according to claim 1, wherein the filter unit is arranged in a direction from the inlet toward the first outlet, and the mesh of the arranged filter unit becomes denser as it approaches the first outlet.

6. The oil purification apparatus according to claim 5, wherein the filter unit has a mesh count in a range from 100 to 3000.

7. The oil purification apparatus according to claim 5, wherein the filter unit comprises a plurality of filter members disposed at intervals between the inlet and the first outlet.

8. The oil purification apparatus according to claim 7, wherein a second filter space between a first filter member and a second filter member among the plurality of filter members, and a third filter space between the second filter member and a third filter member, are connected to the second outlet.

9. The oil purification apparatus according to claim 8, further comprising:
a partition wall disposed in the purification space and positioned between the inlet and the second outlet,
wherein the partition wall is spaced apart from the bottom of the purification space and connected to the first filter member, and
wherein the second filter space and the third filter space are connected to the second outlet through a flow passage between the partition wall and the inner surface of the housing.

10. The oil purification apparatus according to claim 8,
wherein the bottom of the purification space is inclined from one side toward the other side, and
wherein the second outlet is connected to the other side of the bottom of the purification space.

11. The oil purification apparatus according to claim 10, wherein the bottom of the purification space is inclined at an angle of 15° to 25° with respect to a virtual horizontal line.

12. The oil purification apparatus according to claim 1, further comprising an inclination adjusting unit installed on the housing and which may set an inclination of the filter unit.

13. The oil purification apparatus according to claim 12,
wherein the filter unit is arranged in a direction from the inlet toward the first outlet to form a multi-layer, and
wherein the inclination adjusting unit is installed for each of the arranged filter units.

14. The oil purification apparatus according to claim 13, wherein the inclination adjusting unit comprises:
a hinge shaft protruding from the filter unit and rotatably coupled to the housing;
a lever connected to the hinge shaft and rotatably installed on the housing; and
a locking mechanism formed between the lever and an outer circumference of the housing and to which the rotating lever is locked in steps.

15. The oil purification apparatus according to claim 13, further comprising:
a shielding member connecting the filter unit and the circumference of the purification space and blocking moisture from passing between the filter unit and the circumference of the purification space,
wherein the shielding member may be folded and unfolded according to the rotation of the filter unit.

16. The oil purification apparatus according to claim 1, wherein the filter unit is a superhydrophobic filter.

17. The oil purification apparatus according to claim 1, further comprising a storage unit connected to the inlet and that may store oil containing at least one of the moisture and impurities.

18. The oil purification apparatus according to claim 17, wherein the storage unit comprises:
a storage housing having a storage space formed therein;
an inlet pipe formed on the storage housing and supplying oil containing at least one of the moisture and impurities to the storage space;
a level control valve positioned in the storage space, installed on the inlet pipe, and adjusting a liquid level of the storage space; and
a supply pipe formed on the storage housing, connecting the storage space and the purification space, and supplying the oil containing at least one of the moisture and impurities to the purification space.

19. The oil purification apparatus according to claim 18,
wherein a lower end of the inlet pipe and a center of the supply pipe are aligned with each other, and
wherein a height of the center of the inlet is lower than a height of the center of the supply pipe with respect to a bottom surface of the housing, so that the oil containing at least one of moisture and impurities in the storage space is introduced into the purification space by gravity.

20. The oil purification apparatus according to claim 18, further comprising a pre-treatment unit connected to the inlet pipe and that may heat oil containing at least one of moisture and impurities.
